(19) United States
(12) Patent Application Publication
(10) Pub. No.: US 2005/0145094 A1
(43) Pub. Date: Jul. 7, 2005

(54) Easy horn holder

(76) Inventor: Clayton D. Shumake, Eddy, TX (US)

Correspondence Address: Clayton D. Shumake, P. O. Box 548, Eddy, TX, 76524-0548, US

(21) Appl. No.: 10/700,583

(22) Filed: Nov. 5, 2003

(51) Int. Cl. G10G 1/00

(52) U.S. Cl. 84/453

(57) ABSTRACT

An Easy Horn Holder has a shoulder harness (15) that slides over the shoulder. Mounted to the shoulder harness is the adjustable angle assembly (2). A telescoping tube holder assembly (3) slides into the adjustable angle assembly (2) for height adjustment. The swivel tube (10) slides into the telescoping tube holder assembly (3) for forward or reverse location. The swivel tube (10) and telescoping tube holder assembly (3) are adjusted by using sleeve tightener with wing nut (1). The swivel tube clamp (11) holds the horn mounting plate (12) for clockwise or counter clockwise rotation of the musical instrument.

### BACKGROUND

1. Field of the Invention

This invention relates to the support of a musical instrument and more particularly to a support for trumpets or other small brass musical instruments as it relates to the physically challenged musician.

2. Description of Prior Art

Playing a musical instrument is very popular, but some handicapped individuals are prevented from playing by their handicap. The Easy Horn Holder was designed to provide the opportunity to more individuals who desire to play. The Easy Horn Holder supports the instrument, while allowing upward and downward, forward and reverse, and clockwise and counter clockwise movements. Invention proceeds from the background of multiple supports for all varieties of musical instruments as noted in prior art.

### SUMMARY OF THE INVENTION

Object and Advantages

Object of patentable novelty and utility taught by this invention are to provide an Easy Horn Holder that:
Has a shoulder harness that slides over the shoulder; mounted to the harness is the Easy Horn Holder.
Includes adjustable angle assembly that mounts to the harness to provide the proper height, connected to it is the telescoping tube holder that swivels left and right in the adjustable angle assembly.
Has a swivel tube that slides into the telescoping tube holder for positioning the musical instrument inward and outward in relationship to the individual's size.
Has a sleeve tightener with wing nut that holds the position desired once it's achieved.
Has a swivel tube clamp that holds the horn mounting plate that secures the horn; the clamp can rotate on the swivel tube clockwise and counter clockwise and tightens for a fixed position.

The invention accomplishes these objectives: it supports the horn for the normal or handicapped individual while allowing free use of both hands to play the instrument. Easy Horn Holder is adaptable to any size individual; in relationship to the body, the location of the horn can be located just by means of approximate adjustment on the Easy Horn Holder.

### BRIEF DESCRIPTION OF DRAWINGS

The invention is described by appended claims in relation to description of a preferred embodiment with reference to the following drawings that are explained briefly as follows:

FIG. 1 Is an isometric view showing the trumpet, shoulder harness, and the Easy Horn Holder assembled together.

FIG. 2 Is an isometric view showing the assembly of the Easy Horn Holder in relation to trumpet and shoulder harness.

FIG. 3 Is a frontal view of the Easy Horn Holder, and shoulder harness.

FIG. 4 Is a side view of the Easy Horn Holder.

FIG. 5 Shows a frontal view of the Easy Horn Holder, shoulder harness, and trumpet; it also shows 3 side views of the Easy Horn Holder with a trumpet in 3 variable positions.

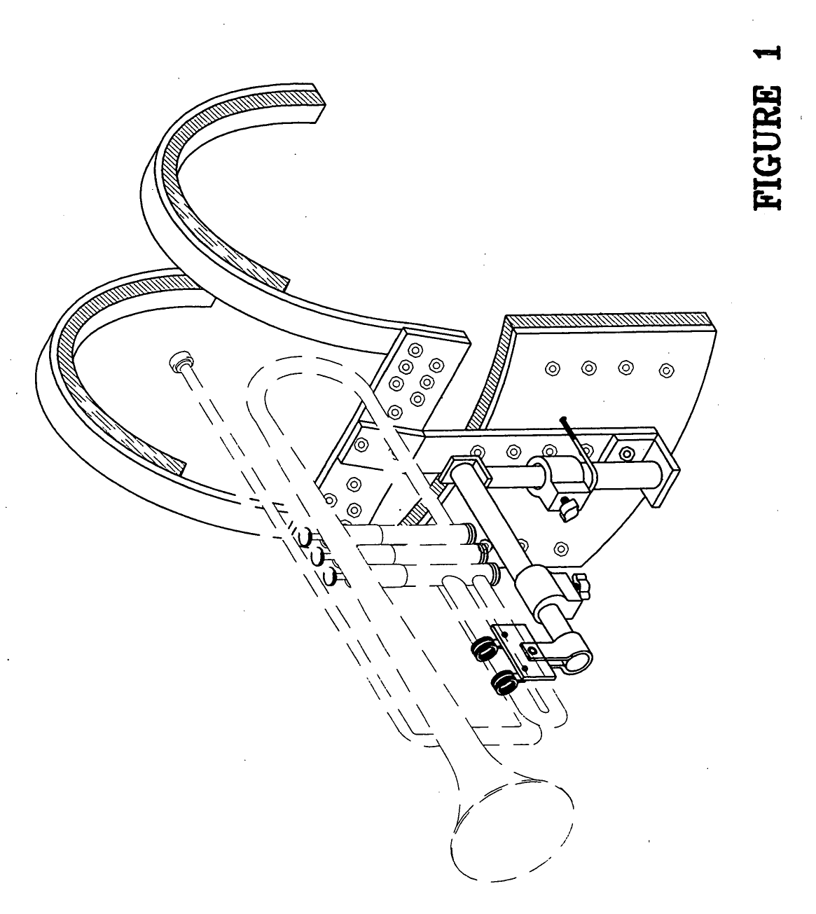

### DESCRIPTIONS OF PREFERRED EMBODIMENT

### Reference Numerals

Listed numerically below with reference to the drawings are terms used to describe features of the invention. These terms and numbers assigned to them designate the same features throughout this description.
1. Sleeve tightener with wing nut
2. Base angle assembly (consist of items 1, 7, 9, 13)
3. Telescoping tube holder assembly (consist of items 1, 5, 6, 8)
4. Wing nut
5. Telescoping vertical tube—angle or height
6. Angle Bar 1×1
7. Angle Bar 1½×1½
8. Horizontal tube
9. Vertical tube
10. Telescoping/swivel tube
11. Swivel tube clamp
12. Horn mounting plate
13. 5/16″ cap screw with nut
14. Chest pad assembly
15. Shoulder harness assembly
16. Screw with nut
17. Horn clamp with cushion

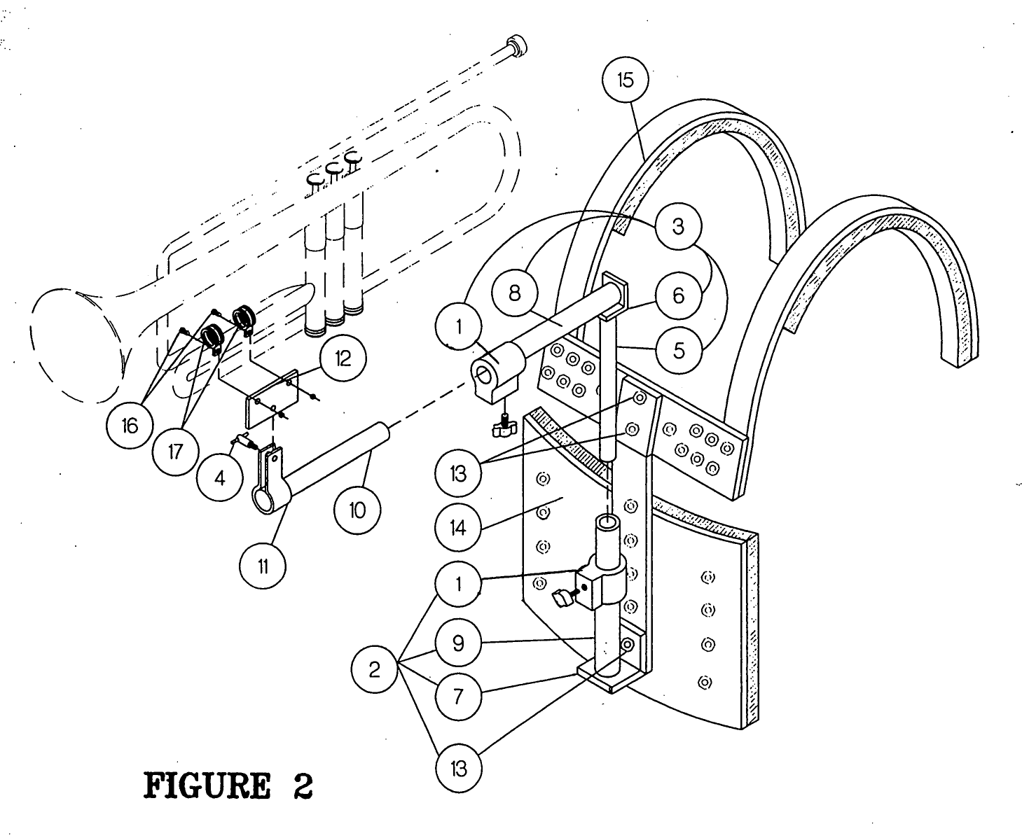

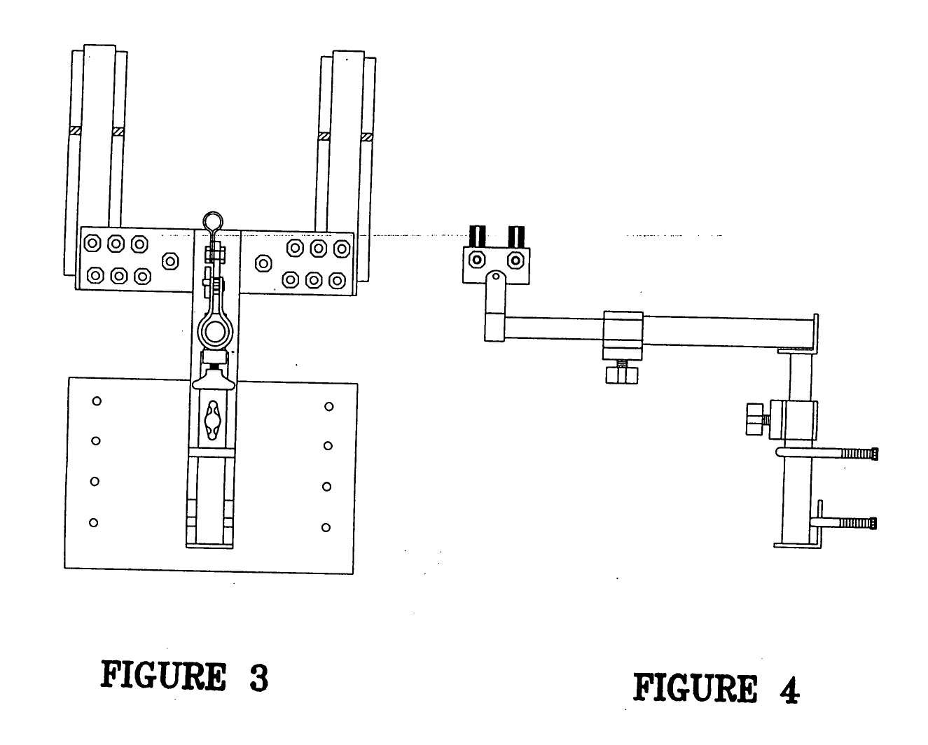

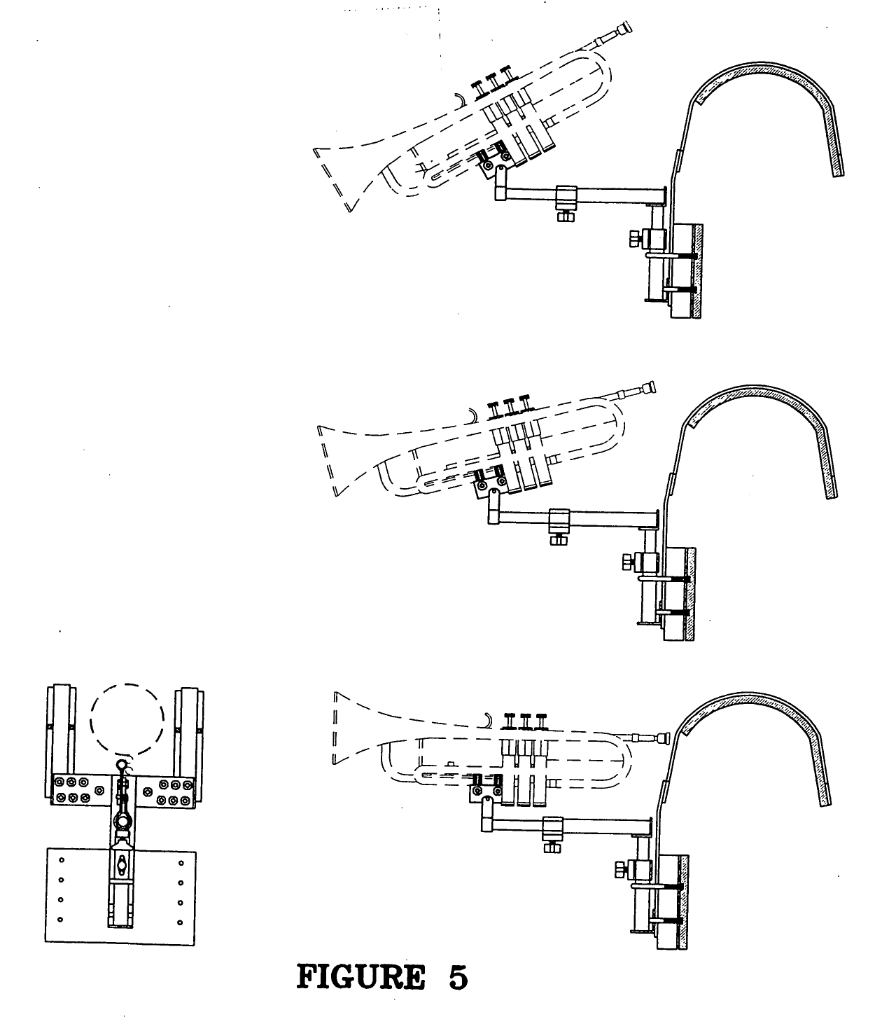

Referring to FIG. 2, the shoulder harness assembly (15) attaches to the chest pad assembly (14) by using the two 5/16″ cap screws with nut (13). The adjustable angle bar 1½×1½ (7) mounts to the shoulder/chest pad assembly (14) by using two 5/16″ cap screws with nut (13), the telescoping vertical tube (9) is welded to the bottom in the center of adjustable angle bar 1½×1½ (7).

The sleeve tightener with wing nut (1) secures the adjustable angle vertical tube (5), that it swivels while welded to the bottom of the adjustable angle bar 1×1 (6) that welds to the telescoping horizontal tube (8), the sleeve tightener slides over the telescoping height tube (8), it secures the swivel tube (10) that slides inward and outward in the telescoping horizontal tube (8). At the end of the swivel tube (10) is the swivel tube clamp (11), the wing nut (4) locks the horn mounting plate (12) in place. The swivel tube clamp (11) can swivel clockwise and counter clockwise, once desired position is found, tighten wing nut (4). The horn clamps with cushions (17) mounts to the horn mounting plate (12) by using the two screws with nuts (16).

The preferred embodiment of the tubing is metal of various thicknesses, but could be made of plastic of various thicknesses.

1. An Easy Horn Holder comprising:
A shoulder harness that slides over the shoulder, mounted to the easy horn holder; the Easy Horn Holder is designed to be adjustable vertically, inward and outwardly, and rotated clockwise and counter clockwise.

2. An Easy Horn Holder of claim 1 wherein:
Shoulder harness that slides over the shoulder; mounted to the easy horn holder, includes adjustable angle assembly that mounts to the harness to provide the proper height.

3. An Easy Horn Holder of claim 2 wherein:
Adjustable angle assembly connected to the telescoping tube holder that swivels left and right for position. Sleeve tightens with wing nut holder to position desired once it's achieved.

4. An Easy Horn Holder of claim 3 wherein:
Telescoping/swivel tube mounts to the telescoping tube holder for inward and outward and swivel positioning of musical instrument.

5. An Easy Horn Holder of claim 4 wherein:
Swivel tube holds the swivel tube clamp that can rotate clockwise and counter clockwise and tighten once desired position is achieved.

6. An Easy Horn Holder of claim 5 wherein:
Mounted to the swivel tube clamp is the horn mounting plate.

7. An Easy Horn Holder of claim 6 wherein:
Mounting plate comprised of horn clamps with cushions that mount to the musical instrument.
